(19) United States
(12) Patent Application Publication
(10) Pub. No.: US 2022/0388313 A1
(43) Pub. Date: Dec. 8, 2022

(54) CAN BODY PRINTING SYSTEM, CAN BODY PRINTING DEVICE, AND CAN BODY

(71) Applicant: ALTEMIRA Co., Ltd., Tokyo (JP)

(72) Inventors: Shinichi OJIMA, Shinagawa-ku, Tokyo (JP); Hitomi MATSUSHIMA, Shinagawa-ku, Tokyo (JP); Kenji FUJINUMA, Shinagawa-ku, Tokyo (JP)

(73) Assignee: ALTEMIRA Co., Ltd., Tokyo (JP)

(21) Appl. No.: 17/783,636

(22) PCT Filed: Dec. 7, 2020
(86) PCT No.: PCT/JP2020/045401

§ 371 Date: Jun. 8, 2022

(30) Foreign Application Priority Data
Jan. 17, 2020 (JP) 2020-006060

(51) Int. Cl. B41J 3/407

(52) U.S. Cl. CPC B41J 3/40733

(57) ABSTRACT

A can body printing system includes: an identification information storage part 302 that stores identification information of a can body; an identification information reading part 303 that reads the identification information attached to the can body; a matching part 304 that matches the read identification information to the identification information stored in the identification information storage part 302; and a print processing part 308 that, upon receiving a matching result, reads print image information from a print image information storage part 307 to perform processing for printing onto the can body by inkjet printing.

### TECHNICAL FIELD

The present invention relates to a can body printing system, a can body printing device, and a can body.

### BACKGROUND ART

Patent Document 1 discloses a technique related to a component monitoring device that detects use of a component other than regular components and then restricts operations of an operating machine.

### CITATION LIST

### Patent Literature

Patent Document 1: Japanese Patent Application Laid-Open Publication No. 2013-101686

### SUMMARY OF INVENTION

### Technical Problem

With recent advances in printing technology for can bodies, it has become practically possible to perform printing on can bodies on the user side, which has conventionally been impossible.

However, if printing is performed onto irregular can bodies on the user side, there is fear that it is impossible to obtain print quality intended by the providers of the can bodies or the providers of the printing device.

An object of the present invention is to provide a can body in which print quality is kept better as compared to the case where a can body is not distinguished from another can body.

### Solution to Problem

A can body printing system to which the present invention is applied includes: a distinction unit distinguishing a can body from another can body; and a control unit controlling to perform printing on the can body distinguished from the another can body.

Here, the distinction unit may distinguish the can body from the another can body by predetermined identification information.

In addition, the identification information may be at least one of an image attached to the can body and a processed portion provided to the can body.

Moreover, the image may be visualized by being irradiated with a light beam of a predetermined wavelength.

Moreover, when the identification information includes a predetermined quantity of can bodies, the control unit may regard the quantity of can bodies to be distinguished from the another can body.

Further, the identification information indicating that the predetermined quantity of can bodies are printable may be directly provided to at least one of the quantity of can bodies, or indirectly provided to the quantity of can bodies.

From another standpoint, a can body printing device to which the present invention is applied includes: an obtaining unit obtaining identification information for distinguishing a can body from another can body; and a printing unit performing printing on the can body from which the identification information was obtained.

In addition, the printing unit may be capable of printing with different print contents for each can body.

From another standpoint, a can body to which the present invention is applied includes: an identification part to be distinguished from another can body; and a printed part on a barrel portion of the can body printed by an inkjet printing method, wherein the can body is filled with a beverage.

Moreover, a can body includes: an identification part to be distinguished from another can body; and a printing region where printing can be performed by an inkjet printing method.

### Advantageous Effects of Invention

According to the present invention, it is possible to provide a can body in which print quality is kept better as compared to the case where a can body is not distinguished from another can body.

### BRIEF DESCRIPTION OF DRAWINGS

FIG. 1 is a diagram showing a hardware configuration of a can body printing system to which the exemplary embodiments are applied;

FIG. 2 is a diagram showing a functional configuration on a printing device side (a printing device, or a printing device and a user PC 40) in a first exemplary embodiment;

FIG. 3 is a diagram showing a functional configuration of a host device in the first exemplary embodiment;

FIG. 4 is a flowchart showing processing in the first exemplary embodiment, which is performed on the printing device side;

FIGS. 5A to 5C are flowcharts each showing processing performed by the host device;

FIG. 6 is a diagram showing a functional configuration on the printing device side in a second exemplary embodiment;

FIG. 7 is a diagram showing a functional configuration of the host device in the second exemplary embodiment;

FIG. 8 is a flowchart showing processing in the second exemplary embodiment, which is performed on the printing device side;

FIG. 9 is a flowchart showing processing in the second exemplary embodiment, which is performed by the host device;

FIGS. 10A to 10C are diagrams each showing an example of a can body to which the exemplary embodiments are applied; and

FIG. 11 is a diagram showing an example of a can body to be printed after being filled with a beverage.

### DESCRIPTION OF EMBODIMENTS

### [Configuration of can Body Printing System]

Hereinafter, with reference to attached drawings, a can body printing system, to which exemplary embodiments are applied, will be described in detail.

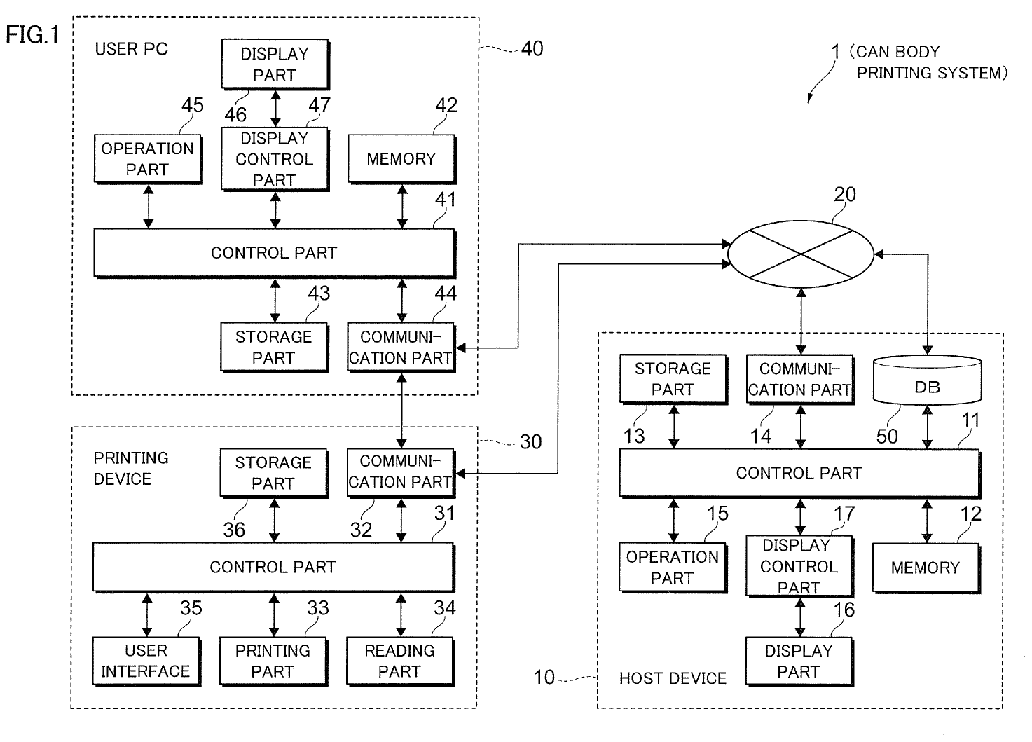

FIG. 1 is a diagram showing a hardware configuration of a can body printing system 1 to which the exemplary embodiments are applied. In the can body printing system 1, a host device 10, which is an information processing device constituting a basis of the can body printing system 1, and a printing device 30 on a user side, which performs printing on can bodies, are connected via a network 20, such as the Internet. In addition, there is a mode in which, on the user side performing printing on the can bodies, a user PC 40 connected to the printing device 30 is connected to the host device 10 via the network 20.

The host device 10 is a computer device provided by, for example, a provider of can bodies on which printing is performed by the printing device 30 or a provider of the printing device 30. To the host device 10, a database (DB) 50 that stores the various pieces of information used by the can body printing system 1 is connected directly or via the network 20.

The host device 10 includes a control part 11, which is a central processing unit (CPU) controlling the entire device, and a memory 12, such as a random access memory (RAM) used as a working area for computing. In addition, a storage part 13 used for storing programs and various kinds of setting data is also included. As the storage part 13, for example, a storage device, such as a semiconductor memory or a hard disk drive (HDD) is used. Further, a communication part 14 that transmits and receives data via the network 20 is also included.

Moreover, the host device 10 also includes an operation part 15, such as a keyboard, a pointing device, and a touch panel, to accept input operations from an administrator managing the can body printing system 1. In addition, a display part 16 including a liquid crystal display, which displays images and text information necessary for administrative work conducted by the administrator, and others, and a display control part 17 controlling the display part 16 are also included. Note that each piece of hardware does not necessarily have a common housing.

The printing device 30 includes a control part 31 controlling the entire device, and a communication part 32 that transmits and receives various kinds of data via the network 20. In addition, a printing part 33 performing printing on the can bodies is also included. A reading part 34 configured by a charge coupled device (CCD) sensor and the like for reading identification information attached to the can body is further included. Moreover, a user interface 35 that performs display to the user who operates the printing device 30 and accepts input operations from the user, and a storage part 36 that stores print image information or the like, which has been obtained, are also included.

The printing part 33 performs inkjet digital printing on the can bodies, and is capable of printing with different print contents for each can body. This is very different from printing on the can body by the normal mechanical printing, which increases convenience for the user and reduces the weight of the device. In the printing part 33, the ink is injected as droplets from a nozzle and adheres to an outer circumferential surface of the can body to form an image on the outer circumferential surface of the can body, and further, the paint is applied onto the image to form a protection layer. The printing part 33 uses, for example, inks of four colors: cyan (C); magenta (M); yellow (Y); and black (K) as the basic inks, and special color inks (special-color inks) prepared for each brand as needed. In addition, in this case, the inkjet head is prepared for each color, to thereby perform image formation onto the can body by use of the plural inkjet heads. Moreover, as the ink to be used, an actinic radiation cure ink is desirable. Here, examples of the actinic radiation cure ink include an ultraviolet (UV) cure ink. After the image formation by the inkjet heads, a paint is applied to the outer circumferential surface of the can body to form the protection layer (overcoat layer).

The can body as a medium on which printing is performed can be the can body before being filled with beer or other beverages, or the can body after being filled with the beverage.

The reading part 34, for example, rotates a can body that is conveyed for printing by the printing part 33 around the axial direction, for example, of the can body during the conveyance, and reads the identification information formed on the surface of the can body. Examples of the identification information read by the reading part 34 include various kinds of bar code information, serial numbers, and various kinds of image information that can be identified. For example, there may be a mode to use an image to be used for image expression on the can body as one of the pieces of the identification information, together with the image to be printed later by the printing part 33. In addition, for example, it may be possible to perform processing to provide concave portions or convex portions on a part of the can body and read thereof.

Note that there is also a mode in which the reading part 34 adopts a configuration that emits ultraviolet light, which is light rays with predetermined wavelength, and then visualizes and reads the identification information drawn with fluorescent paint, to thereby make a user who bought the can body be not aware of existence of the identification information on the can body.

Moreover, the printing device 30 is directly connected to the user PC 40, which is a computer device that the user operates, via an interface cable, or a local area network (LAN) such as an Ethernet (registered trademark). The user PC 40, for example, performs various kinds of settings to the printing device 30, in addition to providing the print image information to the printing device 30. In addition, the user PC 40 is connected to the host device 10 via the network 20 and obtains various kinds of information from the host device 10. In addition to the mode of communicating directly with the host device 10, the communication part 32 of the printing device 30 has a mode to communicate with the host device 10 via the user PC 40. Moreover, there is also a mode to selectively use the above modes in accordance with information.

The user PC 40 includes a control part 41 controlling the entire device, and a memory 42, such as a RAM used as a working area for computing. In addition, a storage part 43 used for storing programs and various kinds of setting data is also included, the storage part 43 including a storage device, such as a semiconductor memory or an HDD. Further, a communication part 44 that transmits and receives data via the network 20 or transmits and receives data by connecting to the printing device 30 is included. Moreover, an operation part 45, such as a keyboard, a pointing device, a touch panel, and a bar-code reader, to accept input operations from a user using the printing device 30 is also included. In addition, a display part 46 including a liquid crystal display, which displays images and text information necessary for print work conducted by the user, and others, and a display control part 47 controlling the display part 46 are also included.

Note that the printing device 30 itself can be grasped as the “can body printing device” in some cases, but it is also possible to inclusively grasp the printing device 30 and the user PC 40 as the “can body printing device.”

### [Functional Configuration of Printing Device 30 in First Exemplary Embodiment]

Next, a description will be given of the functions in the first exemplary embodiment performed on the printing device 30 side (the printing device 30, or the printing device 30 and the user PC 40). The first exemplary embodiment is characterized by the point that the printing device 30 performs operations, such as matching and printing of the identification information, independently or cooperatively with the user PC 40.

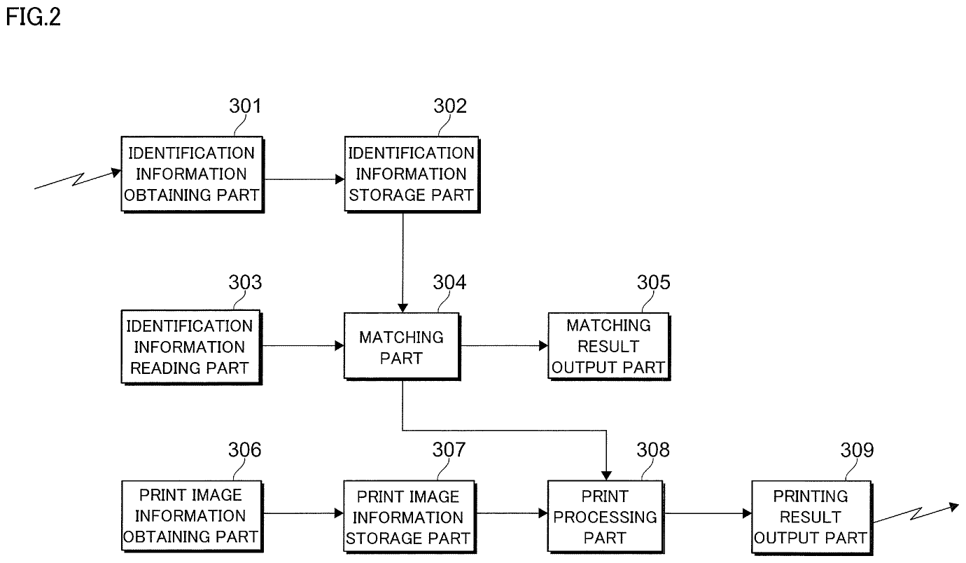

FIG. 2 is a diagram showing a functional configuration on the printing device 30 side (the printing device 30, or the printing device 30 and the user PC 40) in the first exemplary embodiment. The printing device 30 side includes: an identification information obtaining part 301 that obtains the can body identification information from the host device 10 via the network 20; and an identification information storage part 302 that stores the obtained identification information in the storage part 43 of the user PC 40 or the storage part 36 of the printing device 30. In addition, an identification information reading part 303 that reads the identification information attached to the can body by the reading part 34 is also included.

Moreover, the printing device 30 side also includes a matching part 304 that matches the identification information read by the identification information reading part 303 against the identification information stored in the identification information storage part 302. Also, a matching result output part 305 that outputs the matching result to the display part 46 of the user PC 40 or an external device, such as the host device 10, via the network 20 is included.

The printing device 30 side further includes: a print image information obtaining part 306 that obtains the print image information; and a print image information storage part 307 that stores the obtained print image information in the storage part 43 of the user PC 40 or the storage part 36 of the printing device 30. The print image information obtained by the print image information obtaining part 306 is obtained from the host device 10 via the network 20 in some cases, and is, for example, created in the user PC 40 in other cases. In addition, there is also a mode in which the user PC 40 performs changing processing on the image obtained from the host device 10, to thereby obtain thereof as the print image information.

Moreover, the printing device 30 side includes a print processing part 308 that, upon receiving the matching result by the matching part 304, reads the print image information out of the print image information storage part 307, and performs processing for causing the printing part 33 to perform printing. In addition, a printing result output part 309 for outputting the printing results by the print processing part 308 to the host device 10, the display part 46 of the user PC 40, or the like is also included.

### [Functional Configuration of Host Device 10 in First Exemplary Embodiment]

Next, a description will be given of the functions in the first exemplary embodiment performed by the host device 10.

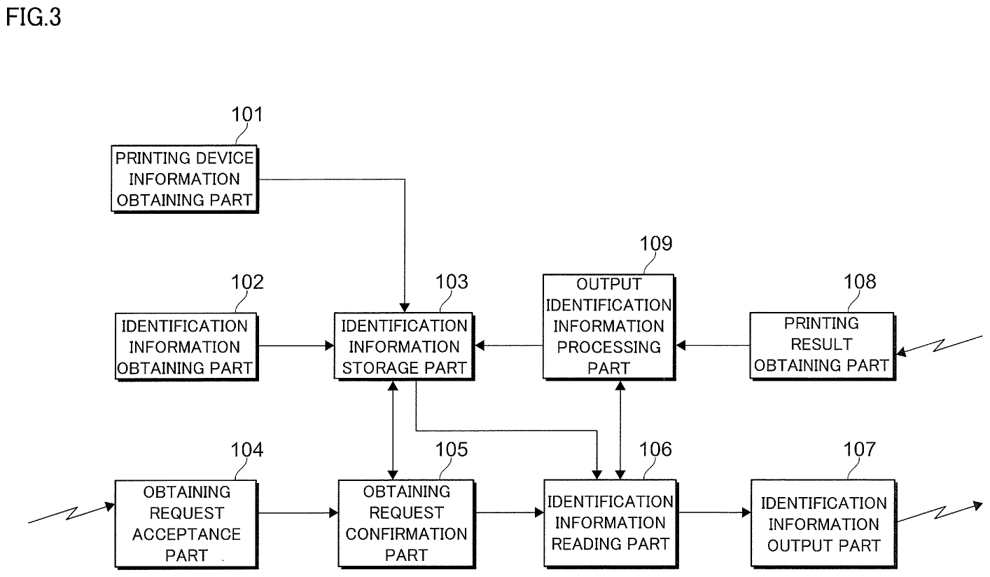

FIG. 3 is a diagram showing a functional configuration of the host device 10 in the first exemplary embodiment. The host device 10 includes: a printing device information obtaining part 101 that obtains, for example, printing device information from other computer devices via the network 20; and an identification information obtaining part 102 that obtains, for example, the identification information from other computer devices via the network 20. In addition, an identification information storage part 103 that stores can body identification information associating the obtained printing device information and identification information with each other in the storage part 13 or the DB 50 is also included.

Other than the case where the printing device information and the identification information are obtained via the network 20 and the communication part 14, there is a mode in which, for example, the printing device information and the identification information are inputted through the operation part 15 by an administrator of the host device 10.

Moreover, the host device 10 includes: an obtaining request acceptance part 104 that accepts an obtaining request for the identification information from the printing device 30; and an obtaining request confirmation part 105 that, based on the printing device information stored in the identification information storage part 103, confirms whether or not the accepted obtaining request is made by the printing device 30 that has been registered. In addition, an identification information reading part 106 that reads the identification information out of the identification information storage part 103, and an identification information output part 107 that outputs the read identification information to the printing device 30 side are also included.

Further, a printing result obtaining part 108 that obtains the printing result from the printing device 30, and an output identification information processing part 109 that recognizes the identification information used in the print processing onto the can body are also included.

Examples of the identification information, which is stored in the identification information storage part 103, to be adopted include, a serial number made up of plural digits, such as more than ten digits, as well as a two-dimensional code and a one-dimensional bar code. In addition, it is also possible to regard an unnumbered dot image as the identification information. A different piece of identification information can be added to each can body, and the piece of identification information can be kept as information capable of uniquely identifying a can body. The identification information is printed on the can body before the can body is distributed to the user. In addition, as the identification information, other than the code information or the serial numbers, various kinds of images that can be distinguished from others can be used. The pieces of can body identification information are grasped by a company supplying the can bodies, and are provided by the computer device of the company to the host device 10.

The printing device information stored in the identification information storage part 103 is information that can uniquely identify the printing device 30 provided to the user. Examples of the printing device information include the serial number of the printing device 30. For example, a user ID, which is the information that uniquely identifies a user using the printing device 30, can be used.

Note that, instead of adding the different piece of code information to each can body, it is also possible to add the same pieces of code information to the plural can bodies. In other words, this is a mode in which a single piece of identification information includes a predetermined quantity of can bodies. For example, the same code information is added for each unit of lot manufactured by a company that supplies the can bodies. It is also possible to use the information such as the manufacturing date as the code information.

In addition, here, the identification information of the can body is associated with the printing device information to be stored; however, there is also a mode in which the identification information of the can body is stored without being associated with the printing device information. For example, only the identification information of the regular can body is stored without administrating the printing device information in some cases.

### [Processing of Printing Device 30 in First Exemplary Embodiment]

Next, a description will be given of the processing performed on the printing device 30 side (the printing device 30, or the printing device 30 and the user PC 40) with reference to FIGS. 1, 2, and 4.

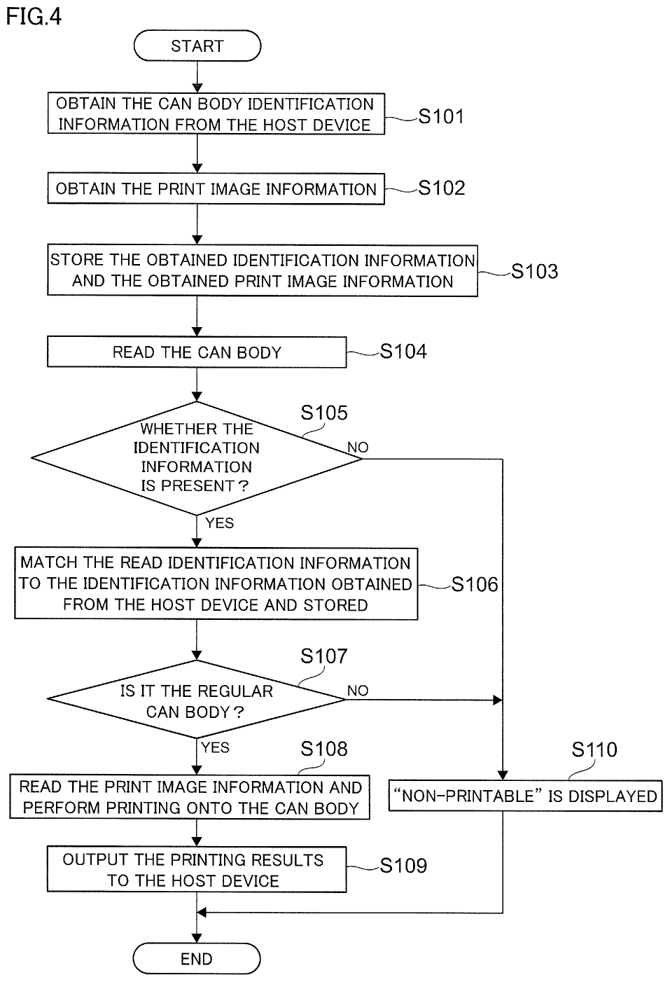

FIG. 4 is a flowchart showing the processing in the first exemplary embodiment, which is performed on the printing device 30 side. First, the identification information obtaining part 301 obtains the can body identification information from the host device 10 via the network 20 (step 101). The print image information obtaining part 306 obtains the print image information from the host device 10, the user interface 35 of the printing device 30, or the operation part 45 of the user PC 40 via the network 20 (step 102). The identification information storage part 302 stores the obtained identification information in the storage part 36 of the printing device 30 or the storage part 43 of the user PC 40, and the print image information storage part 307 stores the obtained print image information in the storage part 36 of the printing device 30 or the storage part 43 of the user PC 40 (step 103).

Next, the identification information reading part 303 of the printing device 30 reads the can body by the reading part 34 (step 104). The matching part 304 determines whether or not the identification information is present as a result of reading the can body (step 105). In the case where the identification information is not present (NO in step 105), “non-printable” is displayed (step 110) and the processing is finished. In the case where the identification information is present (YES in step 105), the matching part 304 matches the read identification information to the identification information obtained from the host device 10 and stored (step 106). The matching includes not only an exact match, but also the case where, for example, a group of can bodies that may permit printing has part of the identification information.

As a result of matching by the matching part 304, in the case where the can body is determined not to be the regular can body (NO in step 107), “non-printable” is displayed (step 110) and the processing is finished. In the case where the can body is determined to be the regular can body (YES in step 107), the print processing part 308 reads the print image information from the print image information storage part 307, and performs printing onto the can body by the inkjet printing (step 108). Then, the printing result output part 309 outputs the printing results to the host device 10 via the communication part 32 and the network 20 (step 109), and the processing is finished. Note that the matching result output part 305 outputs the matching results to the user interface 35 of the printing device 30, the display part 46 of the user PC 40, and/or the host device 10. Specifically, the matching result output part 305 displays “non-printable” in the case where the identification information is not present, or the printing is impossible as a result of matching. Note that, in the case where the matching result indicates the regular can body, printing result is outputted by the printing result output part 309, and thereby it is unnecessary to output the matching result; however, the matching result output part 305 may output the matching result that “the regular can body is used.” Moreover, “non-printable” is displayed in step 110, and in addition, the information “non-printable” can be outputted to the host device 10.

### [Processing of Host Device 10 in First Exemplary Embodiment]

Next, a description will be given of the processing performed by the host device 10 with reference to FIGS. 1, 3, and 5.

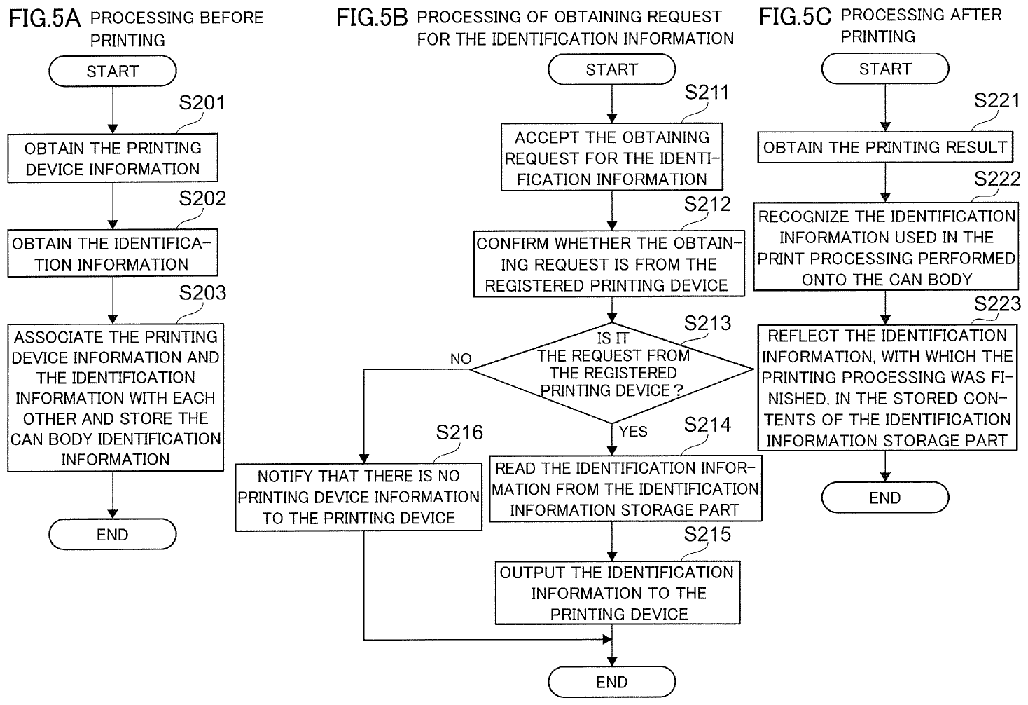

FIGS. 5A to 5C are flowcharts each showing the processing performed by the host device 10. FIG. 5A shows the processing in the host device 10 before printing by the printer device 30, FIG. 5B shows the processing of obtaining request for the identification information in the host device 10, and FIG. 5C shows the processing in the host device 10 after printing by the printing device 30.

First, before printing by the printing device 30, as shown in FIG. 5A, the printing device information obtaining part 101 of the host device 10 obtains the printing device information from, for example, a computer device (not shown) owned by a company that provides the printing device 30 (step 201). In addition, the identification information obtaining part 102 of the host device 10 obtains the identification information from, for example, a computer device (not shown) owned by a company that provides can bodies, such as aluminum cans (step 202). Then, the identification information storage part 103 associates the printing device information and the identification information with each other and stores the can body identification information (step 203), and the processing before printing is finished.

Next, the processing of obtaining request for the identification information will be described. As shown in FIG. 5B, the obtaining request acceptance part 104 of the host device 10 accepts the obtaining request for the identification information from the printing device 30 or the user PC 40 via the network 20 (step 211). The obtaining request confirmation part 105 of the host device 10 confirms whether or not the obtaining request is the obtaining request from the printing device 30 that has been registered based on the printing device information stored in the identification information storage part 103 (step 212). In the case where the request is not from the registered printing device 30 (NO in step 213), the printing device 30 is notified that there is no printing device information (step 216), and the processing is finished. In the case where the request is from the registered printing device 30 (YES in step 213), the identification information reading part 106 reads the can body identification information from the identification information storage part 103 (step 214). Then, the identification information output part 107 outputs the can body identification information that has been read to the printing device 30 via the network 20 (step 215), and the processing of the obtaining request for the identification information is finished.

Further, after printing by the printing device 30, as shown in FIG. 5C, the printing result obtaining part 108 of the host device 10 obtains the printing result from the printing device 30 or the user PC 40 via the network 20 (step 221). Then, the output identification information processing part 109 recognizes the identification information used in the print processing performed onto the can body (step 222), and reflects the identification information, with which the print processing was finished, in the stored contents of the identification information storage part 103 (step 223), and the processing after printing is finished. The reflection into the stored contents performed here means to delete the identification information, to distinguish the identification information from other information by setting some sort of flag, etc., to the identification information, or the like.

Thus, in the first exemplary embodiment, before the print processing by the printing device 30, the can body identification information is obtained on the printing device 30 side (the printing device 30, or the printing device 30 and the user PC 40), and the matching in the printing is performed on the printing device 30 side. In the exemplary embodiment, it is unnecessary to make inquiries via the network 20 one after another in printing. In addition, if a mode to store the identification information allocated to each printing device 30 is adopted, the information amount of the identification information to be obtained is limited. However, depending on how to have the information, it is possible to limit the information amount even in the case where the information is not allocated to each printing device 30. That is, for example, a mode to store information within the range of permissible identification information; for example, to determine permissible conditions from among the identification information (for example, the last few digits are predetermined numbers, etc.), to store thereof, and to make a determination on the printing device 30 side, or the like.

### [Functional Configuration of Printing Device 30 in Second Exemplary Embodiment]

Next, a description will be given of the functions in the second exemplary embodiment performed on the printing device 30 side (the printing device 30, or the printing device 30 and the user PC 40). The second exemplary embodiment is characterized in that the matching of the identification information is performed by the host device 10. Note that, the same reference signs are used for the functions similar to those in the first exemplary embodiment, and detailed descriptions thereof will be omitted.

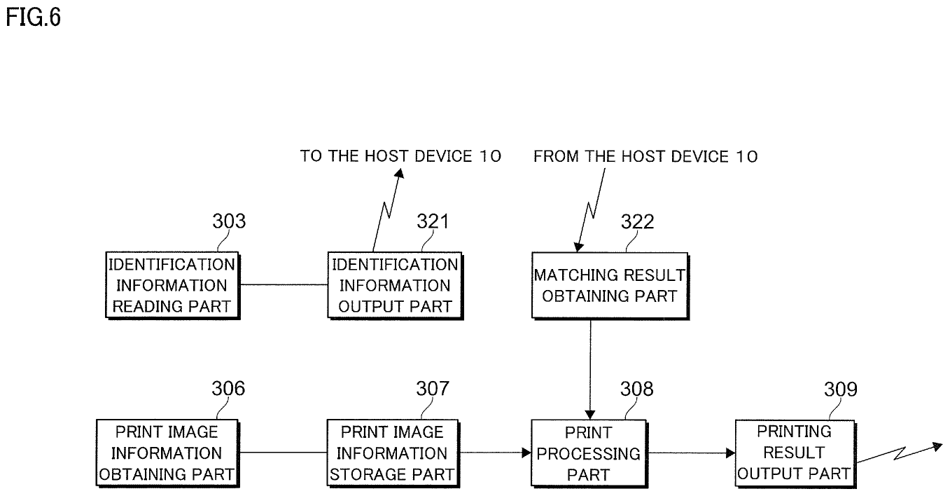

FIG. 6 is a diagram showing a functional configuration on the printing device 30 side in the second exemplary embodiment. The printing device 30 side includes an identification information output part 321 that outputs the identification information read by the identification information reading part 303 to the host device 10. In addition, a matching result obtaining part 322 that obtains the matching results from the host device 10 is also included. In the case where the printing is impossible because the identification information is not present, the identification information output part 321 displays “non-printable” on the printing device 30 side. In addition, in the case where the information of “non-printable” is obtained from the host device, the matching result obtaining part 322 displays “non-printable” on the printing device 30 side.

### [Functional Configuration of Host Device 10 in Second Exemplary Embodiment]

Next, a description will be given of the functions in the second exemplary embodiment performed by the host device 10.

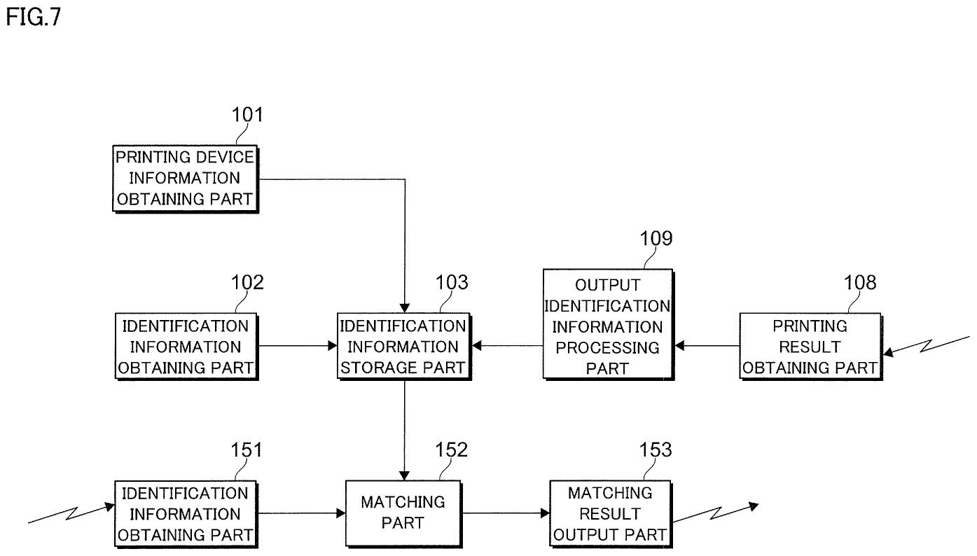

FIG. 7 is a diagram showing a functional configuration of the host device 10 in the second exemplary embodiment. The host device 10 includes an identification information obtaining part 151 that obtains the printing device information and the can body identification information from the printing device 30 side (the printing device 30, or the printing device 30 and the user PC 40). In addition, a matching part 152 that matches the printing device information and the can body identification information that have been obtained against each piece of information stored in the identification information storage part 103 is included. Moreover, a matching result output part 153 that outputs the matching results by the matching part 152 to the printing device 30 side is also included.

### [Processing of Printing Device 30 in Second Exemplary Embodiment]

Next, a description will be given of the processing performed in the second exemplary embodiment on the printing device 30 side (the printing device 30, or the printing device 30 and the user PC 40) with reference to FIGS. 1, 6, and 8.

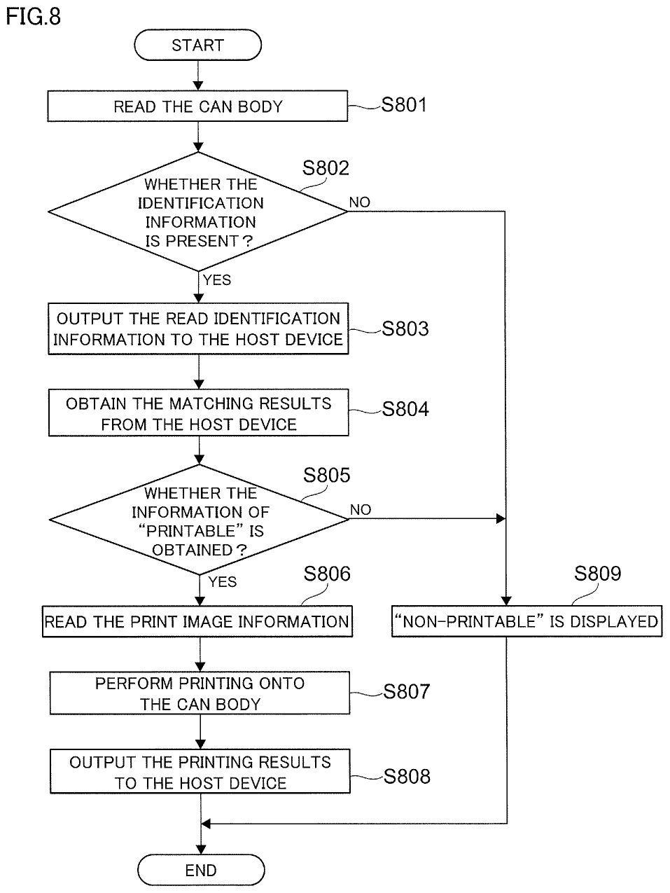

FIG. 8 is a flowchart showing the processing in the second exemplary embodiment, which is performed on the printing device 30 side. First, the identification information reading part 303 on the printing device 30 side reads the can body by the reading part 34 (step 801). Here, it is determined whether or not the identification information is present (step 802), and in the case where the identification information is not present (NO in step 802), the identification information output part 321 displays “non-printable” on the user interface 35 of the printing device 30 or the display part 46 of the user PC 40 (step 809), and the processing is finished. On the other hand, in the case where the identification information is present on the can body (YES in step 802), the identification information that has been read is outputted to the host device 10 via the network 20 (step 803).

Thereafter, the matching result obtaining part 322 of the printing device 30 side obtains the matching results from the host device 10 via the network 20 (step 804). In the case where the information of “non-printable” (to the effect that printing is not permitted) as the matching result is obtained from the host device 10 (NO in step 805), “non-printable” is displayed on the user interface 35 of the printing device 30 or the display part 46 of the user PC 40 (step 809), and the processing is finished. In the case where the information of “printable” (to the effect that printing is permitted) as the matching result is obtained from the host device 10 (YES in step 805), the print processing part 308 reads the print image information from the print image information storage part 307 (step 806), and performs printing onto the can body in the printing part 33 by the inkjet printing (step 807). The printing result output part 309 outputs the printing results to the host device 10 via the communication part 32 and the network 20 (step 808), and the processing is finished.

### [Processing of Host Device 10 in Second Exemplary Embodiment]

Next, a description will be given of the processing in the second exemplary embodiment, which is performed by the host device 10 with reference to FIGS. 1, 7, and 9.

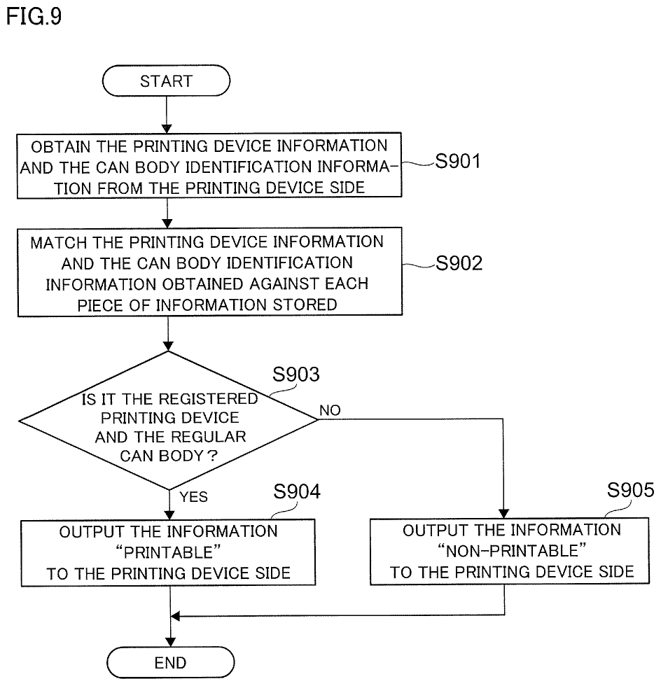

FIG. 9 is a flowchart showing processing in the second exemplary embodiment, which is performed by the host device 10. First, the identification information obtaining part 151 obtains the printing device information and the can body identification information from the printing device 30 side (step 901). The matching part 152 matches the printing device information and the can body identification information obtained in the identification information obtaining part 151 against each piece of information (the printing device information and the can body identification information) stored in the identification information storage part 103 (step 902). In the case where the result of matching by the matching part 152 indicates the registered printing device and the regular can body (YES in step 903), the matching result output part 153 outputs the information of “printable” (to the effect that the printing is permitted) to the printing device 30 side via the network 20 (step 904), and the processing is finished. In the case where the result of matching by the matching part 152 indicates the registered printing device and the irregular can body (NO in step 903), the matching result output part 153 outputs the information of “non-printable” (to the effect that the printing is not permitted) to the printing device 30 side via the network 20 (step 905), and the processing is finished.

According to the second exemplary embodiment, up until the printing by the printing device 30, the host device 10 stores and manages the identification information. The host device 10 adequately performs administration of the identification information, such as updating, and thereby the reliability of the identification information in the can body printing system 1 can be increased. In particular, in the case where a large number of can bodies are managed, the second exemplary embodiment or a mode applying thereof is preferable.

### [Configuration of can Body]

Next, the can body used in the exemplary embodiments (the first and second exemplary embodiments), and the can body after the printing is performed will be described.

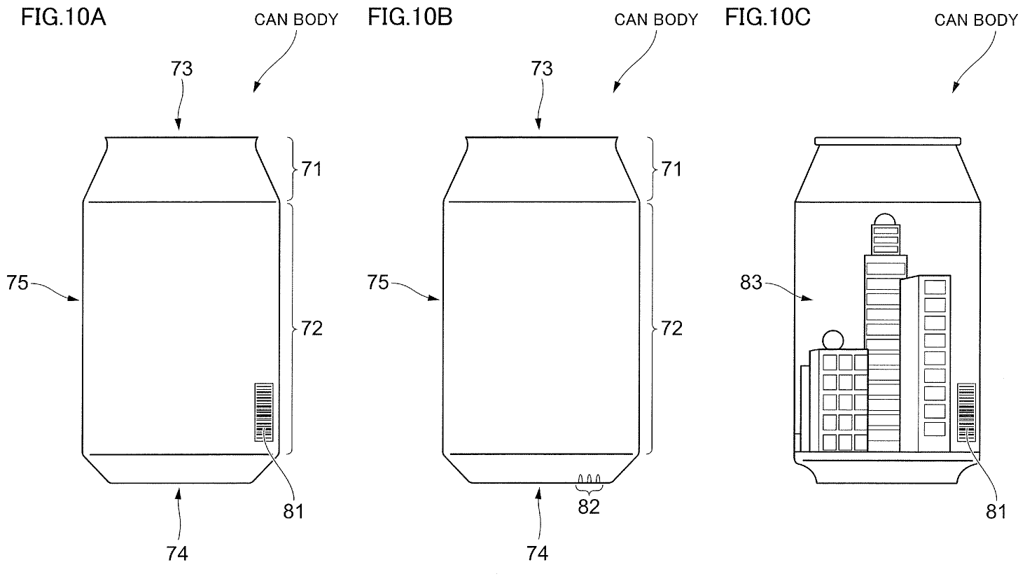

FIGS. 10A to 10C are diagrams each showing an example of the can body to which the exemplary embodiments are applied. FIG. 10A shows an example in which the code information as the identification information is printed on the can body before printing by the printing device 30. FIG. 10B shows an example, in which a processed portion 82 as the identification information is provided to the can body. FIG. 10C shows an example of a can body as a product after printing by the printing device 30.

The can body shown in each of FIGS. 10A and 10B is the can body after the neck treatment has been performed, and is not filled with the contents, such as beverages. The can body includes a diameter decreased portion 71, a barrel portion 72, an opening portion 73, and a bottom portion 74. The diameter decreased portion 71 is located closer to the opening portion 73 of the can body. The diameter decreased portion 71 is formed so that the outer diameter gradually decreases as approaching the opening portion 73. The barrel portion 72 is formed cylindrically to form the main part of the outer circumferential surface 75 of the can body. After printing by the printing device 30, the can body is filled with alcoholic beverages such as beer or Chuhai, or soft drinks (non-alcoholic beverages) from the opening portion 73. Note that, after the filling, a lid member is attached to the opening portion 73 of the can body, and thereby a beverage can that is filled with a beverage is completed.

On the can body shown in FIG. 10A, code information 81 made of a bar code is printed on a side, which is closer to the bottom portion 74, in the barrel portion 72 on the outer circumferential surface 75 to be longitudinal in the axial direction. The code information 81 as one of the pieces of identification information is read by the reading part 34 of the printing device 30. Formation of the code information 81 at the position where the following image to be printed by the printing device 30 are less affected reduces constraints to the image information to be printed. In addition, if the following image is printed at the position superimposed on the code information 81, the position should be the position that makes it easy to perform reading by the reading part 34. In the mode of superimposed printing, it is more preferable to form the code information 81, which is printed on the can body in advance, with shapes and colors that do not affect subsequent printing. Moreover, in accordance with the reading direction of the reading part 34, the code information 81 is formed so that the pieces of information are consecutive in the axial direction of the can body or the circumferential direction of the can body. Further, as described above, to reduce the visibility to the user, it is also preferable to form the code information 81 with, for example, the fluorescent paint, and read the fluorescent paint by the reading part 34.

On the bottom portion 74 of the can body shown in FIG. 10B, instead of the identification information to be printed, or with the identification information, the processed portion 82, which deforms at least a part of the can body, such as to form the concave portions or the convex portions, is provided. The processed portion 82 as the identification information is provided as a mode that can distinguish the can body from the can bodies supplied by the different manufacturers. It is preferable that the processed portion 82 is provided at a position that does not affect the following printing. For example, the position is a predetermined position of the bottom portion 74. For reading the processed portion 82 by the reading part 34, for example, there is a method in which the processed portion 82 is read by a 3D camera, and after that, recognized by performing image processing. In addition, there is also a method to perform recognition based on the shadows of the concaves and convexes.

Note that, in the case of the can body with the opening portion 73 as shown in FIGS. 10A and 10B, the printing part 33 of the printing device 30 inserts a tubular mandrel, which is an example of a support member, into the can body to support the can body from the inside. Then, the mandrel is rotated in the circumferential direction to rotate the can body in the circumferential direction, and thereby the digital printing onto the can body by the inkjet printing is performed.

In the can body as a product shown in FIG. 10C, the code information 81 of the can body shown in FIG. 10A has been recognized by the reading part 34 of the printing device 30, and the image 83 is printed by the printing part 33 of the printing device 30. In the example shown in FIG. 10C, the code information 81 and the image 83 are formed on the barrel portion 72, with different printing regions. Thereafter, the can body is filled with the beverage and the lid member is attached to the can body by the neck treatment; accordingly, the can body as a product is formed and then shipped. Note that, here, the “neck treatment” indicates a combination of the necking processing (processing to decrease the diameter of the opening portion 73 of the can body) and the flanging processing (processing to form a flange to attach the lid member). In the example shown in FIG. 10C, the code information 81 is integrated as a part of the design in the image 83.

In the example shown in FIG. 10A, the image 83 is formed on the can body before being filled with the beverage, but there is also a mode in which the image 83 is formed on the can body that has been filled with the beverage.

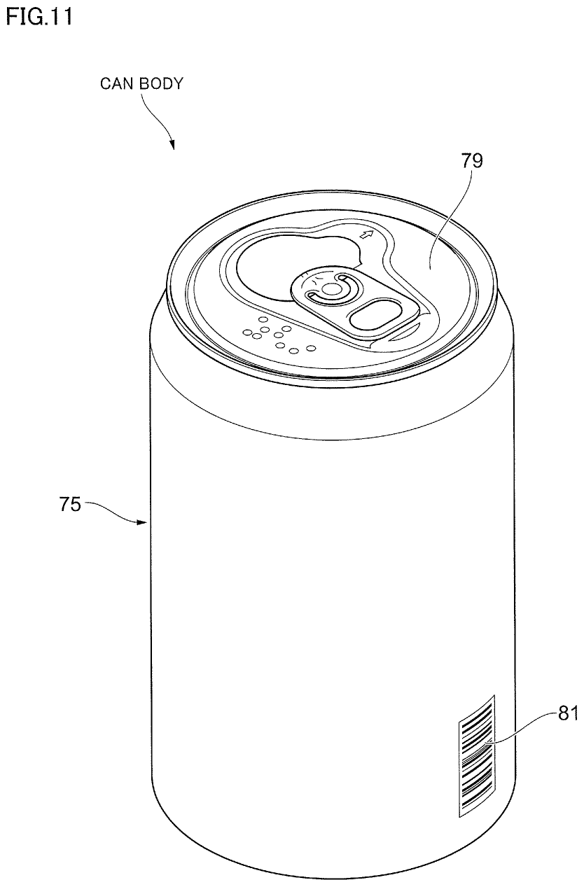

FIG. 11 is a diagram showing an example in which a can body after being filled with a beverage is to be printed. The can body shown in FIG. 11 has already been filled with the beverage, and the lid member 79 has been attached thereto by the neck treatment. In the can body shown in FIG. 11, the code information 81 made of a bar code as the identification information has been printed on the outer circumferential surface 75.

In the example of the can body shown in FIG. 11, for example, a can body that has been filled with a beverage in a beverage manufacturer, such as a beer company, is provided to a user having the printing device 30. The code information 81, which is formed when the can body is provided to the user, is printed, for example, by a beverage manufacturer or by a can manufacturer who delivers a can body, which has not been filled yet with a beverage, to a beverage manufacturer by using an inkjet printing device. The code information exists to uniquely identify the beverage or the can body to be filled. Examples of the user who receive the can bodies in such forms include event companies, hotels, retailers such as major supermarkets, department stores, or convenience stores, and platformers that provide services over the Internet. In the printing part 33 of the printing device 30 used by these users, for example, the can body is held by pinching the top portion with the lid member 79 and the bottom portion 74 to be rotated at the inkjet nozzle position, and thereby the digital printing is performed.

As described in detail above, according to the exemplary embodiments (the first and second exemplary embodiments), the identification information is recognized before printing by the printing device 30. This realizes the print processing onto regular can bodies that are recognized by, for example, manufacturers who supply cans and manufacturers who supply beverages.

Note that, in the exemplary embodiments, the identification information, such as the bar code information, the serial numbers, various kinds of images that could be distinguished from others, and the processed portion such as concaves and convexes, was directly added onto the can body. However, there is also a mode to provide an identification number indirectly, not directly, to the can body. For example, there is a mode to add identification information that includes plural cans to a packaging material, such as cardboards and various kinds of packing materials, that packages the plural cans. Alternatively, a medium, such as paper, with identification information is put inside the packaging material. In these cases, the user on the printing device 30 side inputs the obtained identification information, for example, at the operation part 45 of the user PC 40 or the user interface 35 of the printing device 30 by use of, for example, a bar-code reader or a keyboard. An inquiry about the obtained identification information is sent to the host device 10 to confirm that the can bodies are regular, and thereby the printing is permitted at the printing part 33 of the printing device 30.

### REFERENCE SIGNS LIST

1 Can body printing system
10 Host device
30 Printing device
31 Control part
32 Communication part
33 Printing part
34 Reading part
40 User PC

1. A can body printing system comprising:
a distinction unit distinguishing a can body from another can body; and
a control unit controlling to perform printing on the can body distinguished from the another can body.

2. The can body printing system according to claim 1, wherein the distinction unit distinguishes the can body from the another can body by predetermined identification information.

3. The can body printing system according to claim 2, wherein the identification information is at least one of an image attached to the can body and a processed portion provided to the can body.

4. The can body printing system according to claim 3, wherein the image is visualized by being irradiated with a light beam of a predetermined wavelength.

5. The can body printing system according to claim 2, wherein, when the identification information includes a predetermined quantity of can bodies, the control unit regards the quantity of can bodies to be distinguished from the another can body.

6. The can body printing system according to claim 5, wherein the identification information indicating that the predetermined quantity of can bodies are printable is directly provided to at least one of the quantity of can bodies, or indirectly provided to the quantity of can bodies.

7. A can body printing device comprising:
an obtaining unit obtaining identification information for distinguishing a can body from another can body; and
a printing unit performing printing on the can body from which the identification information was obtained.

8. The can body printing device according to claim 7, wherein the printing unit is capable of printing with different print contents for each can body.

9. A can body comprising:
an identification part to be distinguished from another can body; and
a printed part on a barrel portion of the can body printed by an inkjet printing method, wherein
the can body is filled with a beverage.

10. A can body comprising:
an identification part to be distinguished from another can body; and
a printing region where printing can be performed by an inkjet printing method.
